(19) United States
(12) Patent Application Publication
(10) Pub. No.: US 2021/0380092 A1
(43) Pub. Date: Dec. 9, 2021

(54) VEHICLE ALLOCATION DEVICE, VEHICLE ALLOCATION METHOD, AND COMPUTER READABLE RECORDING MEDIUM

(71) Applicant: TOYOTA JIDOSHA KABUSHIKI KAISHA, Aichi-ken (JP)

(72) Inventors: Hiroshi OYAGI, Gotemba-shi (JP); Yusuke TAKASU, Mishima-shi (JP); Keisuke NAGASAKA, Gotemba-shi (JP); Tomohiro KANEKO, Mishima-shi (JP); Kohji OGASAWARA, Susono-shi (JP)

(21) Appl. No.: 17/338,682

(22) Filed: Jun. 4, 2021

(30) Foreign Application Priority Data
Jun. 5, 2020 (JP) 2020-098862
Mar. 15, 2021 (JP) 2021-041752

(51) Int. Cl. B60W 10/06; G06Q 10/02; B60W 50/00; B60W 40/08

(52) U.S. Cl. CPC B60W 10/06; G06Q 10/02; B60W 2556/45; B60W 40/08; B60W 2510/06; B60W 50/0097

(57) ABSTRACT

A vehicle allocation device includes a processor including hardware, the processor being configured to: determine, for each vehicle, a necessity of suppressing lowering of performance of an internal combustion engine based on vehicle information corresponding to the vehicle; determine a reservation as a first reservation when reservation information corresponding to the reservation of renting the vehicle satisfies a first condition under which suppressing of lowering of the performance is expected; and allocate the vehicle to the reservation based on the reservation information, wherein the processor is configured to allocate, in a case where the reservation is the first reservation, the vehicle satisfying a second condition indicating a high necessity of the suppression of lowering of the performance or the vehicle having a higher necessity of the suppression of lowering of the performance than the other vehicle to the reservation.

The present application claims priority to and incorporates by reference the entire contents of Japanese Patent Application No. 2020-098862 filed in Japan on Jun. 5, 2020.

### BACKGROUND

The present disclosure relates to a vehicle allocation device, a vehicle allocation method, and a computer readable recording medium.

In the related art, there has been known a technique of combusting particulate matters in a vehicle, which has a particle filter provided in an exhaust path of an internal combustion engine, by causing a high-temperature exhaust to react with the particulate matters captured by the particle filter (for example, see JP 2003-155915 A). According to this technique, accumulation of the particulate matters on the particle filter may be suppressed.

Moreover, in an internal combustion engine, lubrication performance may be lowered and deteriorated in some cases since oil is diluted with water due to due condensation or the like. On the other hand, a technique which restores the oil from the diluted state is known (for example, see JP 2015-168379 A).

### SUMMARY

In a vehicle which combusts particulate matters, for example, if an actuation state with a comparatively low load continues in the internal combustion engine, the temperature of exhaust does not easily increase to the temperature at which the particulate matters are combusted. In such a case, the combustion of the particulate matters caused by the exhaust is not advanced, and the accumulated amount of the particulate matters at the particle filter may increase.

Moreover, the state in which oil is diluted with water and deteriorated often occurs in a vehicle in which an internal combustion engine sometimes drives intermittently such as a hybrid vehicle or a plug-in hybrid vehicle.

Such accumulation of the particulate matters and the state in which the performance of the internal combustion engine is lowered such as deterioration of oil may occur in vehicles of a system of renting the vehicles such as car sharing or rental cars.

There is a need for a vehicle allocation device, a vehicle allocation method, and a computer readable recording medium which suppress lowering of the performance of the internal combustion engine in the vehicle.

According to one aspect of the present disclosure, there is provided a vehicle allocation device including a processor including hardware, the processor being configured to: determine, for each vehicle, a necessity of suppressing lowering of performance of an internal combustion engine based on vehicle information corresponding to the vehicle; determine a reservation as a first reservation when reservation information corresponding to the reservation of renting the vehicle satisfies a first condition under which suppressing of lowering of the performance is expected; and allocate the vehicle to the reservation based on the reservation information, wherein the processor is configured to allocate, in a case where the reservation is the first reservation, the vehicle satisfying a second condition indicating a high necessity of the suppression of lowering of the performance or the vehicle having a higher necessity of the suppression of lowering of the performance than the other vehicle to the reservation.

### BRIEF DESCRIPTION OF THE DRAWINGS

FIG. 1 is an exemplary configuration diagram of a car-sharing system including a vehicle allocation device according to a first embodiment;

FIG. 2 is an exemplary block diagram of the car-sharing system including the vehicle allocation device according to the first embodiment;

FIG. 3 is an exemplary block diagram of a control unit and a storage unit of the vehicle allocation device according to the first embodiment;

FIG. 4 is an exemplary flow chart illustrating a procedure of determination of the necessity of reduction of particulate matters of each vehicle by the vehicle allocation device according to the first embodiment;

FIG. 5 is an exemplary flow chart illustrating a procedure of determining a driver by the vehicle allocation device according to the first embodiment;

FIG. 6 is an exemplary flow chart illustrating a procedure of determining a reservation and allocating a vehicle to the reservation by the vehicle allocation device according to the first embodiment;

FIG. 7 is an exemplary flow chart illustrating a procedure of determining the necessity of reducing an oil deterioration degree of each vehicle by a vehicle allocation device according to a second embodiment;

FIG. 8 is an exemplary block diagram of a control unit and a storage unit of the vehicle allocation device according to a third embodiment;

FIG. 9 is an exemplary schematic diagram illustrating a configuration of a neural network learned by a learning unit of a vehicle allocation device according to the third embodiment; and

FIG. 10 is an exemplary explanatory diagram of input/output of nodes of the neural network according to the third embodiment.

### DETAILED DESCRIPTION

Hereinafter, exemplary embodiments of the present disclosure are disclosed. The configurations according to the embodiments shown below and operations and results (effects) brought about by the configurations are examples. The present disclosure may be realized by those other than the configurations disclosed in the following embodiments. Moreover, according to the present disclosure, at least one of the various effects (including derivative effects) obtained by the configurations described below may be obtained.

The plurality of embodiments shown below are provided with similar configurations. Therefore, according to the configurations according to the embodiments, similar operations and effects based on the similar configurations may be obtained. Moreover, hereinafter, these similar configurations are denoted by similar reference signs, and redundant descriptions will be omitted.

Note that, in the present specification, ordinal numbers are given for the sake of convenience in order to distinguish conditions, reservations, drivers, vehicles, etc. and do not indicate priorities or orders. Moreover, “information” is assumed to represent values or data of parameters, and “accumulation of particulate matters” is assumed to represent accumulation of particulate matters at a particle filter.

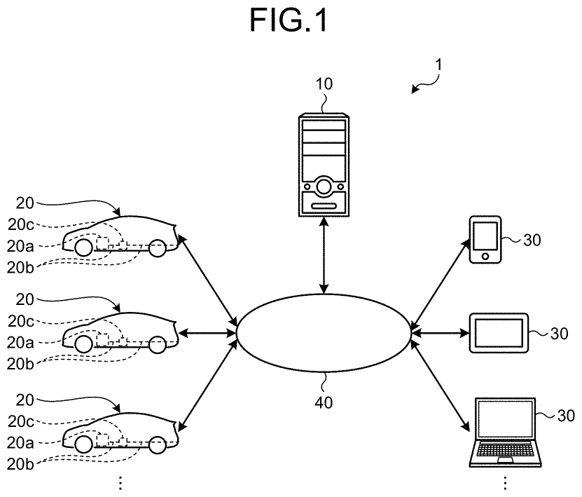

FIG. 1 is a configuration diagram of a car-sharing system 1. As illustrated in FIG. 1, the car-sharing system 1 includes a server 10, vehicles 20, and terminals 30.

The server 10 is a computer and executes a process of allocating any one of the plurality of vehicles 20 to a reservation of the vehicle 20 from the terminal 30, i.e., a so-called car assignment process. The server 10 is an example of a vehicle allocation device.

At least some of the vehicles 20 have an internal combustion engine 20a, which changes an actuation state depending on a driving operation of the vehicle 20 carried out by a driver, and a particle filter 20c, which is provided in an exhaust path 20b of the internal combustion engine 20a for capturing particulate matters contained in exhaust. The internal combustion engine 20a is a drive source of the vehicle 20 such as a gasoline engine or a diesel engine. Note that the vehicle 20 may be provided with a rotating electric machine other than the internal combustion engine 20a as a drive source. Moreover, the internal combustion engine 20a is not necessarily the drive source of the vehicle 20, but may be, for example, an internal combustion engine which rotates an electric power generator for supplementing the driving electric power of the rotating electric machine serving as the drive source of the vehicle 20.

A user of the car-sharing system 1 may make a reservation of rental of the vehicle 20 via the terminal 30. The terminal 30 is an electronic device such as a smartphone, a tablet, or a personal computer.

The server 10, the vehicles 20, and the terminals 30 may communicate data indicating various information via a communication network 40 including wired or wireless communication lines in accordance with a predetermined communication protocol. The communication network 40 is also referred to as electric communication lines or a computer network and may have various forms.

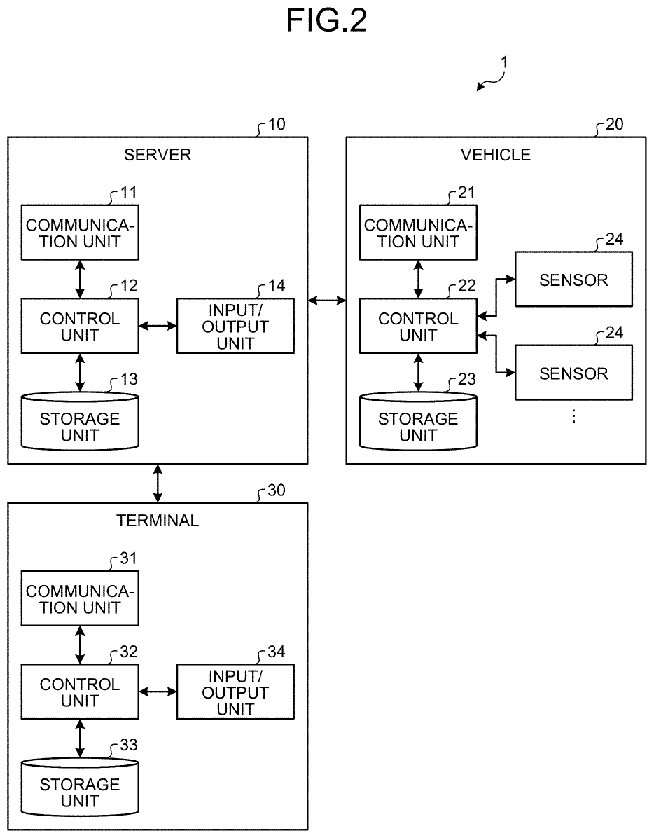

FIG. 2 is a block diagram of the car-sharing system 1. As illustrated in FIG. 2, the server 10 includes a communication unit 11, a control unit 12, a storage unit 13, and an input/output unit 14.

The communication unit 11 communicates data with the vehicle 20 or the terminal 30. Moreover, the input/output unit 14 includes an input device(s) such as a keyboard, a mouse, and/or a touch panel and an output device(s) such as a display and/or a loudspeaker. The input/output unit 14 is a user interface for an administrator or an operator of the car-sharing system 1. The control unit 12 and the storage unit 13 of the server 10 will be described later in detail.

The vehicle 20 includes a communication unit 21, a control unit 22, a storage unit 23, and a plurality of sensors 24. The communication unit 21 communicates data with the server 10 or the terminal 30.

The control unit 22 is a computer and includes a processor (circuit) such as a central processing unit (CPU) and a main storage unit such as a random access memory (RAM) or a read only memory (ROM). The control unit 22 is, for example, a micro controller unit (MCU). The storage unit 23 includes a non-volatile storage device such as a solid state drive (SSD) or a hard disk drive (HDD). The storage unit 23 is also referred to as an auxiliary storage device. The control unit 22 and the storage unit 23 are included, for example, in an electronic control unit (ECU).

The processor reads a program(s) stored in the ROM or the storage unit 23 and executes processing. Each of the programs may be recorded and provided in a file having an installable format or an executable format in a computer-readable recording medium. The recording medium is also referred to as a program product. Information such as values, tables, and maps used in computation processing by the program and the processor may be stored in the ROM or the storage unit 23 in advance or may be stored in a storage unit of a computer connected to the communication network and stored in the storage unit 23 by downloading via the communication network. The storage units 13 and 23 stores data written by the processor. Moreover, the computation processing by the control unit 22 may be executed, at least partially, by hardware. In this case, the control unit 22 may include, for example, a field programmable gate array (FPGA) or an application specific integrated circuit (ASIC).

The sensors 24 detect various physical quantities about driving of the vehicle 20 or actuation of the internal combustion engine 20a. Moreover, the sensors 24 include the sensors 24, which detect various physical quantities about generation of particulate matters by the internal combustion engine 20a and combustion of the particulate matters at the particle filter 20c. The sensors 24 like this are, for example, a sensor configured to detect the speed of the vehicle 20, a sensor configured to detect the acceleration of the vehicle 20, a sensor configured to detect the operation amount of a gas pedal, a sensor configured to detect the revolution speed of the internal combustion engine 20a, a sensor configured to detect the temperature of the particle filter 20c or the temperature of an exhaust gas of the internal combustion engine 20a, a sensor configured to detect an intake airflow, and a sensor configured to detect a differential pressure between the front and the rear of the particle filter 20c. The global positioning system (GPS), which may acquire time and the position of the vehicle 20, is also an example of the sensor 24.

The control unit 22 may calculate values about the generation of the particulate matters by the internal combustion engine 20a and the combustion of the particulate matters at the particle filter 20c (hereinafter, referred to as calculation values) based on detection values detected by the sensors 24.

Moreover, the control unit 22 may write the detection values and the calculation values in the storage unit 23. In other words, the storage unit 23 may store the detection values from the sensors 24 and the calculation values based on the detection values. Moreover, the control unit 22 may control the communication unit 21 so as to transmit the detection values and the calculation values to the server 10.

The terminal 30 includes a communication unit 31, a control unit 32, a storage unit 33, and an input/output unit 34.

The communication unit 31 communicates data with the server 10 or the vehicle 20. Moreover, the input/output unit 34 includes an input device(s) such as a keyboard, a mouse, and/or a touch panel and an output device(s) such as a display and/or a speaker. The input/output unit 34 is a user interface for a user (person who makes a reservation) of the car-sharing system 1.

The control unit 32 is a computer and has a processor (circuit) such as a CPU and a main storage unit such as a RAM or a ROM. The storage unit 33 has a non-volatile storage device such as an SSD or an HDD. The storage unit 33 is also referred to as an auxiliary storage device.

The processor reads a program(s) stored in the ROM or the storage unit 33 and executes processing. Each of the programs may be recorded and provided in a file having an installable format or an executable format in a computer-readable recording medium. The recording medium is also referred to as a program product. Information such as values, tables, and maps used in computation processing by the program and the processor may be stored in the ROM or the storage unit 33 in advance or may be stored in a storage unit of a computer connected to the communication network and stored in the storage unit 33 by downloading via the communication network. The storage unit 33 stores data written by the processor. Moreover, the computation processing by the control unit 32 may be executed, at least partially, by hardware. In this case, the control unit 32 may include, for example, FPGA, ASIC, etc.

The control unit 32 actuates an application (program, hereinafter, referred to as a reservation app), which executes a reservation of the vehicle 20 in the car-sharing system 1. The reservation app is configured as a stand-alone app or a web app. The control unit 32 acquires the information which is input from the input/output unit 34 by actuation of the reservation app. By actuation of the reservation app, the control unit 32 controls the communication unit 31 so as to transmit the information, which has been input by the input/output unit 34, to the server 10 and controls the communication unit 31 so as to receive the information transmitted from the server 10 to the terminal 30. Moreover, by actuation of the reservation app, the control unit 32 subjects the information, which has been acquired by the input/output unit 34 from the server 10, to display output or sound output.

The information input from the input/output unit 34 includes reservation information indicating a request of reservation to rent the vehicle 20. The reservation information includes, for example, in addition to identification information of the driver, drive (rental) start time, a drive start location, drive (rental) end time, a drive end location, a planned stopover (including a destination), a planned drive route, information indicating presence/absence of usage of an expressway, attribute information of the driver, etc.

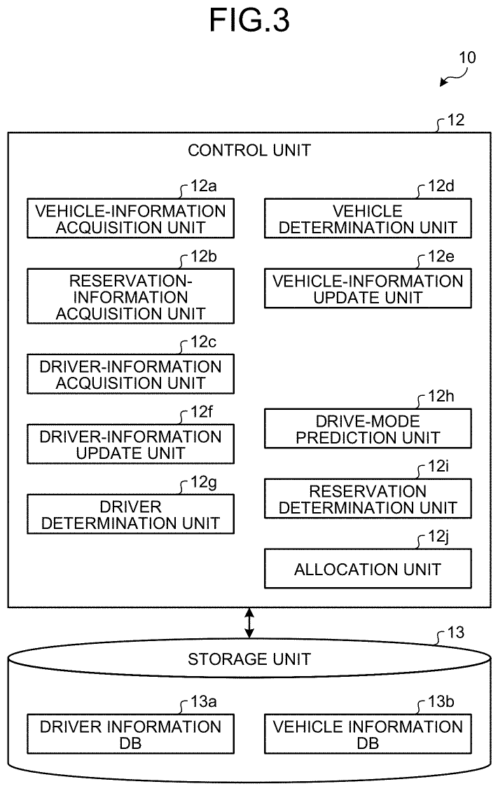

FIG. 3 is a block diagram of the control unit 12 and the storage unit 13 of the server 10. As illustrated in FIG. 3, the control unit 12 has a vehicle-information acquisition unit 12a, a reservation-information acquisition unit 12b, a driver-information acquisition unit 12c, a vehicle determination unit 12d, a vehicle-information update unit 12e, a driver-information update unit 12f, a driver determination unit 12g, a drive-mode prediction unit 12h, a reservation determination unit 12i, and an allocation unit 12j. Moreover, the storage unit 13 has a driver-information database 13a, which stores driver information, and a vehicle-information database 13b, which stores vehicle information. Note that, in FIG. 3, the databases are described as DB.

The control unit 12 is a computer and has a processor (circuit) such as a CPU and a main storage unit such as a RAM or a ROM. The storage unit 13 has a non-volatile storage device such as an SSD or an HDD. The storage unit 13 is also referred to as an auxiliary storage device.

The processor actuates as the vehicle-information acquisition unit 12a, the reservation-information acquisition unit 12b, the driver-information acquisition unit 12c, the vehicle determination unit 12d, the vehicle-information update unit 12e, the driver-information update unit 12f, the driver determination unit 12g, the drive-mode prediction unit 12h, the reservation determination unit 12i, and the allocation unit 12j by reading a program(s) stored in the ROM or the storage unit 13 and executing processing. Each of the programs may be recorded and provided in a file having an installable format or an executable format in a computer-readable recording medium. The recording medium is also referred to as a program product. Information such as values, tables, and maps used in computation processing by the program and the processor may be stored in the ROM or the storage unit 13 in advance or may be stored in a storage unit of a computer connected to the communication network and stored in the storage unit 13 by downloading via the communication network. The storage unit 13 stores data written by the processor. Moreover, the computation processing by the control unit 12 may be executed, at least partially, by hardware. In this case, the control unit 12 may include, for example, FPGA, ASIC, etc.

In the driver-information database 13a, the driver information is stored in correspondence to the identification information of the driver. In other words, the driver information is the information associated with the identification information of the driver. The driver information includes, as the information indicating a drive record of the driver, for example, information indicating an average speed, a drive distance, drive time, the number of times of acceleration at predetermined acceleration or higher, and an average acceleration in acceleration. The driver information includes information about accumulation of the particulate matters. The information about accumulation of the particulate matters is, for example, a category that shows drivers who are likely to carry out drive that reduces the accumulated amount of the particulate matters, the amount of change in the accumulated amount of the particulate matters caused by driving of the driver, etc., as described later. Moreover, the driver information includes attribute information indicating the attribute of the driver. Accumulation of the particulate matters is an example of the factor that lowers the performance of the internal combustion engine 20a.

Moreover, in the vehicle-information database 13b, the vehicle information is stored in correspondence to the identification information of the vehicle 20. In other words, the vehicle information is the information associated with the identification information of the vehicle 20. Moreover, the vehicle information includes, as the information about accumulation of the particulate matters of each vehicle 20, for example, the accumulated amount of the particulate matters of each vehicle 20 calculated based on the values detected by the sensors 24, and maps, tables, coefficients of functions, etc. set for each vehicle 20 or vehicle model for calculating the accumulated amount or the amount of change of the particulate matters from the values detected by the sensors 24. Moreover, the vehicle information may include temporal changes of the values detected by the sensors 24 in past driving of the vehicle 20 or calculation values based on the detection values. The vehicle information includes a category, a rank, and/or a value indicating the necessity of reduction of the particulate matters (hereinafter, referred to as necessity of reduction). Moreover, the vehicle information includes attribute information of the vehicle 20 such as a size (class), a capacity, and a type. Note that the maps, tables, coefficients of functions, etc. for calculating the accumulated amount or the amount of change of the particulate matters from the detection values may be stored in the storage unit 23 of each vehicle 20.

The vehicle-information acquisition unit 12a acquires the vehicle information of each vehicle 20 from the vehicle 20 or the vehicle-information database 13b.

The reservation-information acquisition unit 12b acquires the information about reservations of the vehicles 20 (hereinafter, referred to as reservation information) from the terminals 30.

The driver-information acquisition unit 12c acquires the driver information from the vehicles 20 or the driver-information database 13a.

The vehicle determination unit 12d determines the necessity of reduction at the particle filter 20c of each vehicle 20. The necessity of the reduction is an example of the necessity of suppressing lowering of the performance of the internal combustion engine 20a.

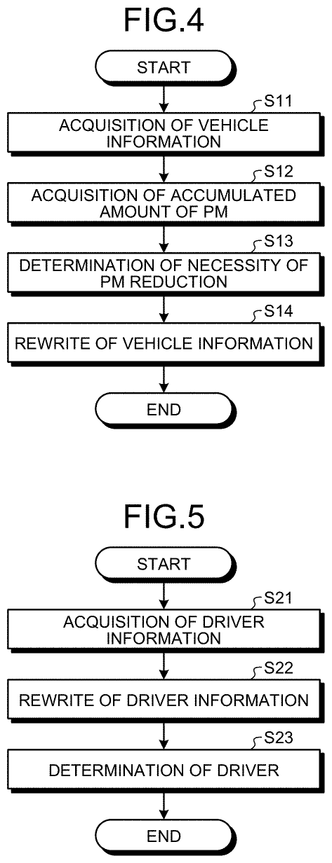

FIG. 4 is a flow chart illustrating a processing procedure of determination of the necessity of reduction by the vehicle determination unit 12d. The processing illustrated in FIG. 4 may be executed at various timing such as a point of time immediately after the vehicle 20 is returned, a point of time when the vehicle 20 becomes an option to be allocated to a reservation (a point of time before allocation), and a predetermined point of time which is periodically set. Note that, in FIG. 4, the particulate matters are described as PM.

Before the determination of the vehicle 20 by the vehicle determination unit 12d, the vehicle-information acquisition unit 12a acquires the vehicle information corresponding to the vehicle 20 from at least one of the vehicle 20 and the vehicle-information database 13b (S11). As an example, the vehicle-information acquisition unit 12a acquires temporal changes of the values detected by the sensors 24 from the vehicle 20 and acquires, from the vehicle-information database 13b, maps, tables, coefficients of functions, etc. for calculating the increased amount and reduced amount of the particulate matters from the detection values in addition to the accumulated amount of the particulate matters in the vehicle 20.

Next, the vehicle determination unit 12d acquires the accumulated amount of the particulate matters of the vehicle 20 based on the vehicle information acquired in S11 (S12).

In S12, the vehicle determination unit 12d may execute computation of estimating the accumulated amount of the particulate matters based on the vehicle information acquired in S11. This example will be described. It has been found out that the increased amount of the accumulated amount of the particulate matters per unit time changes depending on the load of the internal combustion engine 20a and the revolution speed of the internal combustion engine 20a. It has been also found out that the reduced amount of the particulate matters in the combustion at the particle filter 20c per unit time changes depending on the temperature of the particle filter 20c and the flow rate of the exhaust gas of the internal combustion engine 20a. Moreover, the load of the internal combustion engine 20a may be expressed by the operation amount of the gas pedal, and the flow rate of the exhaust gas may be expressed by the flow rate of the intake air of the internal combustion engine 20a. Therefore, in S11, the vehicle-information acquisition unit 12a acquires, from the vehicle 20, the temporal changes of the operation amount of the gas pedal, the revolution speed of the internal combustion engine 20a, the temperature of the particle filter 20c, and the flow rate of the intake air as the temporal changes of the values detected by the sensors 24 in a predetermined period. Herein, the predetermined period is a period for calculating the increased/reduced amount of the particulate matters at the particle filter 20c after the point of time at which the accumulated amount of the particulate matters has been previously calculated and is, for example, a period from the start to end (return) of rental of the vehicle 20 in car sharing. Moreover, in S11, the vehicle-information acquisition unit 12a acquires, from the vehicle-information database 13b or the vehicle 20, a map indicating the correlation between the operation amount of the gas pedal corresponding to the vehicle 20, the revolution speed of the internal combustion engine 20a, and the increased amount of the particulate matters per unit time (hereinafter, referred to as an increase map) and a map indicating the correlation between the temperature of the exhaust gas corresponding to the vehicle 20, the flow rate of the intake air, and the reduced amount of the particulate matters per unit time (hereinafter, referred to as a reduction map). Furthermore, in S11, the vehicle-information acquisition unit 12a acquires, from the vehicle-information database 13b or the vehicle 20, the accumulated amount of the particulate matters of the vehicle 20 at a point before the predetermined period (hereinafter, referred to as a remaining amount Qp) as the vehicle information. Then, in S12, the vehicle determination unit 12d calculates the increased amount ΔQi of the particulate matters at the particle filter 20c in the predetermined period from the information indicating the temporal changes of the operation amount of the gas pedal and the revolution speed of the internal combustion engine 20a in the predetermined period and from the increase map. Moreover, the vehicle determination unit 12d calculates the reduced amount ΔQd of the particulate matters at the particle filter 20c in the predetermined period from the information indicating the temporal changes of the temperature of the exhaust gas and the flow rate of the intake air in the predetermined period and from the reduction map. As a result, the vehicle determination unit 12d may calculate the accumulated amount Q of the particulate matters at the present point of time, in other words, at a point after the predetermined period has elapsed by a following equation (1).

Q=Qp+ΔQi−ΔQd (1)

Moreover, as another example, in a case in which the vehicle 20 includes the sensor 24 configured to detect intake airflow and the sensor 24 configured to detect the differential pressure between the front and the rear of the particle filter 20c as the sensors 24, the control unit 22 of the vehicle 20 may acquire the accumulated amount Q as needed based on, for example, a mathematical expression or a map indicating the correlation between the detection values of the sensors 24 and the accumulated amount Q from the detection values of the sensors 24. In this case, in S12, the vehicle determination unit 12d may acquire the accumulated amount Q of the particulate matters of a predetermined point of time, for example, the point of time of end of rental of the vehicle 20 in car sharing (the point of time of return) from the vehicle information acquired in S11. Note that the computation of the accumulated amount Q of the particulate matters based on the intake airflow and the differential pressure between the front and the rear of the particle filter 20c may be carried out by the vehicle determination unit 12d based on the vehicle information acquired in S11.

Next, in S13, the vehicle determination unit 12d determines the necessity of reduction for each vehicle 20 based on the acquired accumulated amount Q of the particulate matters. As an example, the vehicle determination unit 12d may determine the vehicle 20 as a vehicle that has a high necessity of reduction if the accumulated amount Q is equal to or higher than a predetermined threshold value and may determine the vehicle 20 as a vehicle that has a low necessity of reduction if the accumulated amount Q is less than the threshold value. The predetermined threshold value is set, for example, for each vehicle 20 or vehicle model. The fact that the accumulated amount Q is equal to or higher than the predetermined threshold value is an example of a second condition. Moreover, as another example, the vehicle determination unit 12d may calculate the amount of change of the accumulated amount Q per unit length of the drive distance of the vehicle 20 from the past record of the accumulated amount Q, therefore, calculate the drive distance which is taken until the amount reaches the maximum allowable accumulated amount (allowed distance) and determine the necessity of reduction based on the allowed distance. In this case, the vehicle determination unit 12d may determine the vehicle 20 as the vehicle that has a high necessity of reduction if the allowed distance is equal to or less than a corresponding threshold distance and determine the vehicle 20 as the vehicle that has a low necessity of reduction if the allowed distance is longer than the threshold distance. The fact that the allowed distance is equal to or less than the corresponding threshold distance is an example of the second condition. Moreover, as another example, a plurality of categories (ranks) corresponding to the necessities of reduction may be set based on the accumulated amount Q, the allowed distance, other parameters corresponding to the accumulated amount Q, etc., and the vehicle determination unit 12d may determine the rank of each vehicle 20 in S13. Furthermore, as another example, a parameter which indicates the necessity of reduction by a numerical value may be set, and the vehicle determination unit 12d may calculate the value of the parameter in S13. The parameter is set, for example, so that the shorter the allowed distance, the larger the parameter, and this means that the larger the value, the higher the necessity of reduction. Moreover, the control unit 12 writes the information, which indicates the necessity of reduction of each vehicle 20, in the storage unit 13 in correspondence to the identification information of the vehicle 20.

After S12 or S13, the vehicle-information update unit 12e rewrites the vehicle information of the vehicle-information database 13b (S14).

The driver determination unit 12g illustrated in FIG. 3 determines whether the driver is a driver who is likely to carry out the drive that reduces the particulate matters accumulated at the particle filter 20c (hereinafter, referred to as reduction drive).

FIG. 5 is a flow chart illustrating a processing procedure of determination of the driver by the driver determination unit 12g. The processing illustrated in FIG. 5 may be executed at various timing such as a point of time immediately after the vehicle 20 is returned, a point of time when the vehicle 20 becomes an option to be allocated to a reservation (a point of time before allocation), and a predetermined point of time which is periodically set.

Before the determination of the driver by the driver determination unit 12g, the driver-information acquisition unit 12c acquires the driver information from the driver-information database 13a or from the vehicle 20 and the driver-information database 13a (S21). As an example, in S21, the driver-information acquisition unit 12c acquires, from the vehicle 20, temporal changes of the values detected by the sensors 24 in a predetermined period and the drive time of the vehicle 20 in the predetermined period. Herein, the values detected by the sensors 24 are, for example, the speed, acceleration, drive distance, etc. of the vehicle 20. Moreover, the predetermined period is a period after the point of time at which the driver information has been previously updated and, for example, is a period from the start to end (return) of rental of the vehicle 20 in car sharing. Moreover, the driver-information acquisition unit 12c acquires an average speed, a drive distance, drive time, the number of times of acceleration at predetermined acceleration or higher, and average acceleration in acceleration from the driver-information database 13a as records of drive carried out by the driver.

Then, the driver-information update unit 12f calculates an average speed, a drive distance, drive time, the number of times of acceleration at predetermined acceleration or higher, and average acceleration in acceleration taken until the end of the predetermined period, wherein the predetermined period is added to the period of the past records, based on the driver information acquired from the vehicle 20 and the driver-information database 13a and stores, in other words, rewrites these as new driver information in the driver-information database 13a (S22). Note that, if the driver information has already been updated, in S21, the driver-information acquisition unit 12c acquires the record of the drive carried out by the driver, in other words, an average speed, a drive distance, drive time, the number of times of acceleration at predetermined acceleration or higher, and average acceleration in acceleration from the driver-information database 13a as the driver information, and S22 is omitted.

Then, the driver determination unit 12g determines whether the driver is the driver who is likely to carry out the reduction drive or not based on the driver information acquired in S21 or the driver information updated in S22 (S23). In this S23, if the driver information indicating the drive record of the driver satisfies a predetermined condition (an example of a third condition) that reduction of the accumulated amount of the particulate matters by drive is expected, the driver determination unit 12g determines the driver as the driver who is likely to carry out the reduction drive. Hereinafter, in the first embodiment, the driver who is likely to carry out the drive that reduces the accumulated amount of the particulate matters is referred to as a first driver.

In S23, as an example, if the average speed is equal to or higher than a corresponding threshold speed and if the drive distance is equal to or higher than a corresponding threshold distance or the drive time is equal to or higher than corresponding threshold time, the driver determination unit 12g may determine the driver as the first driver. As another example, if the number of times of acceleration at predetermined acceleration or higher is equal to or higher than a corresponding number of times of a threshold value or if the average acceleration in acceleration is equal to or higher than threshold acceleration, the driver determination unit 12g may determine the driver as the first driver. The control unit 12 writes the information, which indicates whether the driver is the first driver or not, in the driver-information database 13a in correspondence to the identification information of the driver.

Moreover, in S23, as further another example, the driver determination unit 12g may determine whether the driver is the first driver or not based on the amount of change of the accumulated amount of the particulate matters according to the drive record of the driver. In this case, for example, after S12 of FIG. 4 (or after S11 if the accumulated amount of the particulate matters may be obtained from the vehicle 20), the driver-information acquisition unit 12c acquires the amount of change of the accumulated amount of the particulate matters in a predetermined period and acquires the drive time or the drive distance in the predetermined period (S21). In this case, the sign of the amount of change of the accumulated amount is positive if it is increased and is negative if it is reduced. Then, the driver-information update unit 12f calculates the amount of change of the accumulated amount of the particulate matters, drive distance, or drive time taken until the end of the predetermined period, wherein the predetermined period is added to the period of the past records, based on the driver information acquired from the vehicle 20 and the driver-information database 13a and stores, in other words, rewrites these as new driver information in the driver-information database 13a (S22). Then, if the amount of change of the accumulated amount of the particulate matters per unit length of the drive distance is equal to or less than a corresponding threshold value or if the amount of change of the accumulated amount of the particulate matters per unit time of the drive time is equal to or less than a corresponding threshold value, the driver determination unit 12g determines that the driver is the first driver (S23). Also in this case, the control unit 12 writes the information, which indicates whether the driver is the first driver or not, in the driver-information database 13a in correspondence to the identification information of the driver.

The reservation determination unit 12i illustrated in FIG. 3 determines whether the reservation is a reservation which satisfies a condition that reduction of the particulate matters is expected (an example of a first condition) or not based on the reservation information acquired from the terminal 30. The drive-mode prediction unit 12h predicts the drive mode of the vehicle 20 based on the reservation information. Moreover, the allocation unit 12j selects the vehicle 20, which satisfies a condition determined by the reservation information (reservation condition), from among the vehicles 20 managed by the car-sharing system 1 and allocates the vehicle to the reservation. Note that, hereinafter, in the first embodiment, the reservation in which reduction of the particulate matters is expected, in other words, the reservation which is likely to be the reduction drive will be referred to as a first reservation as an example.

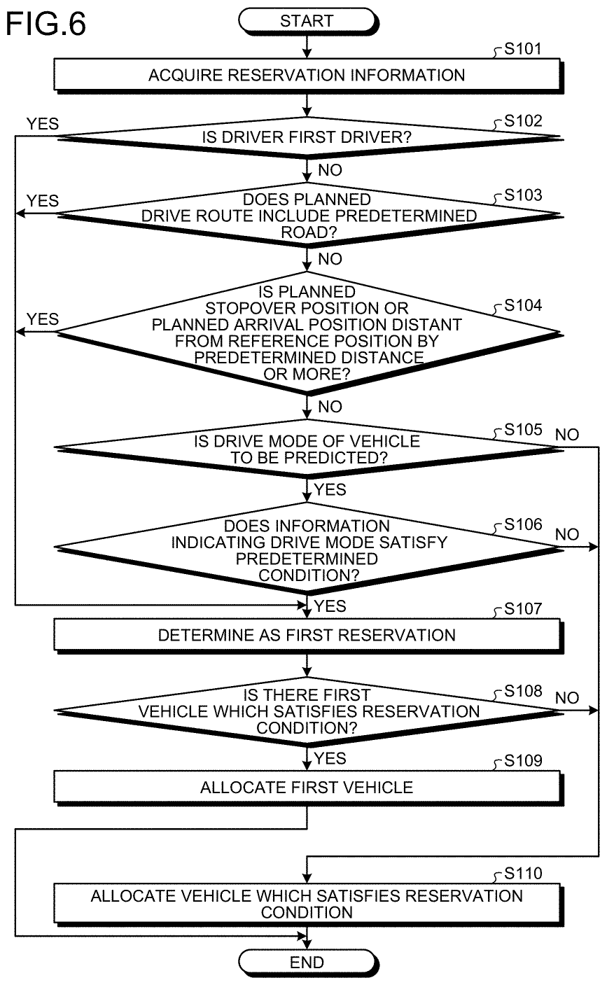

FIG. 6 is a flow chart illustrating a processing procedure of reservation determination by the reservation determination unit 12i and allocation of the vehicle 20 to a reservation by the allocation unit 12j. First, the reservation determination unit 12i acquires the reservation information from the terminal 30 (S101). Then, the reservation determination unit 12i checks the driver-information database 13a and sees if the driver included in the reservation information is the first driver or not (S102). If the driver is the first driver (Yes in S102), the reservation determination unit 12i determines that the reservation is the first reservation (S107).

Moreover, in a case of NO in S102, if the reservation information includes a planned drive route and the planned drive route is a predetermined road (Yes in S103), the reservation determination unit 12i determines that the reservation is the first reservation (S107). The predetermined road is a road on which a maximum speed is equal to or higher than a predetermined speed (for example, 50 [km/h]) such as an expressway, a road dedicated for automobiles, or a high-standard road, in other words, is a road on which driving may be carried out at a comparatively high speed. This is for a reason that, if the vehicle 20 drives at a comparatively high speed, it is likely to be the reduction drive. Moreover, the predetermined road may be, for example, a road registered in advance or a zone of the road such as a road having a zone in which a rising gradient having a predetermined value or higher ranges over a predetermined length or the zone. This is for a reason that, if the vehicle 20 goes up a slope having a comparatively large gradient, it is likely to be the reduction drive. Moreover, like this case, the reservation determination unit 12i may carry out the determination by distinguishing the predetermined roads by each passing direction. The information indicating the planned drive route is an example of planned path information.

Moreover, in a case of NO in S103, if the reservation information includes a planned stopover position or a planned arrival position and the planned stopover position or the planned arrival position is distant from a reference position by a predetermined distance (for example, 50 km) or more (Yes in S104), the reservation determination unit 12i determines that the reservation is the first reservation (S107). The planned arrival position is, for example, a farthest destination of a route, and the reference position is, for example, a standby position, a storage position, a rental start position, a rental end position, etc. of the vehicle 20. This is for a reason that, if it is planned to travel comparatively far, the speed of the vehicle 20 tends to be high, and it is likely to be the reduction drive. The information indicating the planned stopover position or the planned arrival position is an example of the planned path information.

Moreover, if the server 10 includes a navigation function, the drive-mode prediction unit 12h may predict drive modes of the vehicle 20 such as a drive path, a drive road, an average speed, a drive distance, drive time, and the number of times of acceleration from the information of the destination or stopover included in the reservation information. Moreover, the drive-mode prediction unit 12h may predict the drive mode of the vehicle 20, which is driven by the driver, more accurately from the driver information, which corresponds to the identification information of the driver included in the reservation information and indicates the record of the drive carried out by the driver. The driver information indicating the record of the drive carried out by the driver is, for example, an average speed, a drive distance, drive time, the number of times of acceleration at predetermined acceleration or higher, and average acceleration in acceleration, etc. In this case, the drive-mode prediction unit 12h may, for example, predict passage of an expressway if the average speed in the drive record is higher than a corresponding threshold value, predict passage of a general road which is not an expressway if the ratio of the drive time to the drive distance calculated from the drive record is longer than a corresponding threshold value, predict that the larger the number of times of acceleration at predetermined acceleration or higher in the drive record, the higher the frequency of acceleration at the predetermined acceleration or higher, and predict that acceleration is carried out at the average acceleration in the acceleration in the drive record.

In a case of NO in S104 and a case in which the drive-mode prediction unit 12h predicts the drive mode of the vehicle 20 as described above (Yes in S105), if the information indicating the drive mode satisfies a predetermined condition (Yes in S106), the reservation determination unit 12i determines that the reservation is the first reservation (S107). In S106, the information indicating the predicted drive mode is, for example, at least one of the information indicating a predicted average speed, a predicted drive distance, predicted drive time, and a predicted number of times of acceleration. If at least one of the information indicating the predicted average speed, the predicted drive distance, the predicted drive time, and the predicted number of times of acceleration is equal to or higher than a corresponding threshold value(s), in other words, if a corresponding condition(s) (fourth condition) is satisfied, the reservation determination unit 12i determines that the reservation is the first reservation.

In S107, if the reservation determination unit 12i determines that the reservation is the first reservation, the allocation unit 12j checks the vehicle-information database 13b and sees if the allocatable available vehicles 20, which are the vehicles 20 satisfying the reservation conditions such as the size (class) of the vehicle, capacity, and the type of vehicle, include the vehicle 20 which satisfies the above described second condition indicating that the necessity of reduction is high (hereinafter, referred to as a first vehicle) or not (S108).

If the plurality of vehicles 20 satisfying the reservation conditions include the first vehicle (Yes in S108), the allocation unit 12j allocates the first vehicle to the reservation (S109). In S109, if a plurality of first vehicles which satisfy the reservation condition is present, the allocation unit 12j may, for example, subject the vehicle 20 having the highest necessity of reduction, in other words, the vehicle 20 having a higher necessity of reduction than the other vehicles 20 to allocation based on the values of ranks and parameters or subject any one of the vehicles 20 of the plurality of first vehicles to allocation by another condition(s). Then, the control unit 12 controls the communication unit 11 to transmit the information, which indicates that the vehicle 20 (first vehicle) has been reserved, to the terminal 30.

In a case of NO in S105, in a case of NO in S106, and in a case of NO in S108, the allocation unit 12j allocates the vehicle, which is the vehicle 20 satisfying the reservation condition, but is not the first vehicle, to the reservation (S110). In this case, the control unit 12 controls the communication unit 11 so as to transmit the information, which indicates that the vehicle 20 (the vehicle 20 which is not the first vehicle) has been reserved, to the terminal 30. However, if the vehicle 20 which satisfies the reservation condition is not present, the control unit 12 controls the communication unit 11 so as to transmit the information, which indicates a fact that the vehicle 20 which may be reserved is not present, to the terminal 30.

Note that the order of the determination of S102, S103, S104, and S105 (and S106) may be switched.

As described above, in the present embodiment, in the server 10 (vehicle allocation device), the vehicle determination unit 12d determines the necessity of reducing the accumulation on the particle filter 20c for each vehicle 20 based on the vehicle information corresponding to the vehicle 20. The reservation determination unit 12i determines the reservation as the first reservation if the reservation information corresponding to the reservation satisfies the first condition, under which reduction of the particulate matters is expected. Moreover, if the reservation is the first reservation, the allocation unit 12j may allocate the vehicle 20, which has a higher necessity of reducing the accumulated particulate matters than the other vehicles 20, to the reservation based on the reservation information.

According to the configuration and control like this, the vehicle, which has a high necessity of reducing the accumulated particulate matters, may be allocated to the first reservation, in which the reduction of the particulate matters accumulated at the particle filter 20c is expected. Therefore, accumulation of the particulate matters in the vehicle may be suppressed by the allocation of the vehicle to the reservation. Moreover, shortening of the vehicle life may be suppressed by suppressing the accumulation of the particulate matters in the vehicle. Moreover, occurrence of a situation in which vehicle assignment concentrates on particular vehicles and causes unbalance in the accumulation of the particulate matters may be suppressed.

In the above described first embodiment, a factor that lowers the performance of the internal combustion engine 20a is accumulation of the particulate matters on the particle filter 20c. On the other hand, in a second embodiment, a factor that lowers the performance of the internal combustion engine 20a is deterioration of an oil property (of engine oil) in the internal combustion engine 20a. The more the oil is diluted with the water generated by due condensation or the like in the internal combustion engine 20a, the higher the deterioration degree. It is known that the oil diluted with water in this manner becomes milky. Therefore, in the second embodiment, a server, which is an example of the allocation device, is configured to allocate a vehicle, which has a high necessity of reducing the deterioration degree of oil, to a first reservation, in which reduction (including improvement) of the deterioration degree of oil is expected, for example, since dew condensation does not easily occur, and executes control to carry out the allocation.

The vehicle 20 in the second embodiment is, for example, a vehicle such as a hybrid vehicle or a plug-in hybrid vehicle which is equipped with a rotating electric machine as a drive source and sometimes intermittently drives an internal combustion engine. Moreover, the sensor 24 may detect, for example, an air temperature, humidity, and altitude, which are external environmental information, and the number of revolutions, load, the water temperature of cooling water, and the oil temperature of oil, which are usage states of the internal combustion engine 20a, as various physical quantities about driving of the vehicle 20 or actuation of the internal combustion engine 20a. The control unit 22 of the vehicle 20 may calculate a calculation value about the deterioration degree of the oil based on the detection values detected by the sensor 24.

In the second embodiment, the driver information stored in the driver-information database 13a of the server 10, which is an example of the allocation device, is, for example, the number of revolutions, the degree of load, or the frequency of intermittent drive of the internal combustion engine 20a as the information indicating drive records of the driver. The driver information includes information about reduction of the deterioration degree of the oil. The information about reduction of the deterioration degree of the oil is, for example, the category indicating the drivers who have a high possibility of carrying out the drive that reduces the deterioration degree of the oil, the amount of change in the deterioration degree of the oil caused by the drive of the driver, etc.

Moreover, the vehicle information stored in the vehicle-information database 13b may include, for example, following information as, for example, the information about reduction of the deterioration degree of the oil of each vehicle 20 calculated based on the values detected by the sensor 24. The information is, for example, the deterioration degree of the oil in each vehicle 20 calculated based on the detection values and maps, tables, and coefficients of functions set for each vehicle 20 or vehicle model for calculating the deterioration degree or the changed amount of the oil from the values detected by the sensor 24. Moreover, the vehicle information may include time-course changes of the values detected by the sensor 24 in the past drive of the vehicle 20 and the calculation values based on the detected values. The vehicle information includes the category, class, and value that indicates the necessity of reducing the deterioration degree of the oil. Moreover, the vehicle information may include the distance travelled after recent oil exchange and the brand of used oil. Note that the maps, tables, coefficients of functions, etc. for calculating the deterioration degree or the changed amount of the oil from the detection values may be stored in the storage unit 23 of each vehicle 20. Note that the higher the water amount in the oil, the higher the deterioration degree of the oil, and a map or the like that associates the deterioration degree with the water amount may be stored in the vehicle-information database 13b or in the storage unit 23 of each vehicle 20.

In the second embodiment, the vehicle determination unit 12d determines the necessity of reducing the deterioration degree of the oil in the internal combustion engine 20a of each vehicle 20. The necessity of reducing the deterioration degree of the oil is an example of the necessity of suppressing lowering of the performance of the internal combustion engine 20a.

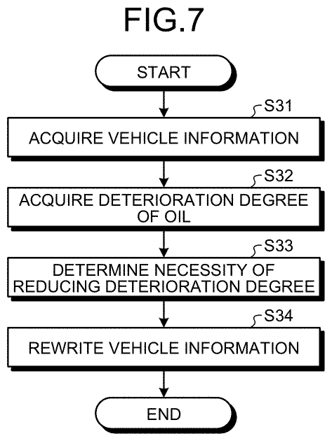

FIG. 7 is a flow chart illustrating a processing procedure of determination of reduction of the deterioration degree of the oil by the vehicle determination unit 12d. The process illustrated in FIG. 7 is executed at various timing, for example, at a point of time immediately after the vehicle 20 is returned, a point of time when the vehicle 20 becomes an option to be allocated to a reservation, and a periodically-set predetermined point of time.

Before the determination of the vehicle 20 by the vehicle determination unit 12d, the vehicle information acquisition unit 12a acquires vehicle information corresponding to the vehicle 20 from at least one of the vehicle 20 and the vehicle-information database 13b (S31).

Then, the vehicle determination unit 12d acquires the deterioration degree of the oil of the vehicle 20 based on the vehicle information acquired in S31 (S32). In S32, the vehicle determination unit 12d may execute computation of quantitative estimation of the deterioration degree of the oil by a predetermined calculation method based on the vehicle information acquired in S31. Note that, when the deterioration degree of the oil is to be acquired, if the information about the property, etc. of the oil at a point when oil exchange is executed before that is added thereto, the precision of the acquired deterioration degree is enhanced.

Then, in S33, the vehicle determination unit 12d determines the necessity of reducing the deterioration degree of the oil for each vehicle 20 based on the acquired deterioration degree of the oil. As an example, if the deterioration degree of the oil is equal to or higher than a predetermined threshold value, the vehicle determination unit 12d may determine that the vehicle 20 is a vehicle that has a high necessity of reducing the deterioration degree of the oil; and, if the deterioration degree of the oil is less than the predetermined threshold value, the vehicle determination unit 12d may determine that the vehicle 20 is a vehicle that has a low necessity of reducing the deterioration degree of the oil. The predetermined threshold value may be set, for example, for each vehicle 20 or vehicle model. A fact that the deterioration degree of the oil is equal to or higher than the predetermined threshold value is an example of a second condition.

After S32 or S33, the vehicle-information update unit 12e rewrites the vehicle information of the vehicle-information database 13b (S34).

In the second embodiment, the driver determination unit 12g determines whether the driver is a driver who has a high possibility of carrying out the drive that reduces the deterioration degree of the oil. The flow chart illustrating the processing procedure of the determination of the driver by the driver determination unit 12g is similar to the first embodiment illustrated in FIG. 5. However, in the second embodiment, the values detected by the sensors 24 used in acquisition of the driver information and the driver information to be rewritten may be the same or different as/from those of the first embodiment.

Moreover, based on the acquired driver information or the updated driver information, the driver determination unit 12g determines whether the driver is a driver who has a high possibility of carrying out the drive that reduces the deterioration degree of the oil. In this determination, if the driver information indicating the drive record of the driver satisfies a predetermined condition (an example of a third condition), under which the deterioration degree of the oil may be expected to be reduced by driving, the driver determination unit 12g determines that the driver is a driver who has a high possibility of carrying out the drive that reduces the deterioration degree of the oil. Hereinafter, in the second embodiment, the driver who has the high possibility of carrying out the drive that reduces the deterioration degree of the oil will be referred to as a first driver.

As an example, if the average speed is equal to or higher than a corresponding threshold speed due to, for example, a high frequency of usage of express ways, the driver determination unit 12g may determine that the driver is the first driver. Moreover, as an example, if the drive distance is equal to or higher than a corresponding threshold distance, the driver determination unit 12g may determine that the driver is the first driver since drive is continuously carried out by the degree that reduces the deterioration, for example, by the degree that increases the oil temperature to 80° C. or higher. Moreover, as an example, if average load or total load is equal to or higher than threshold load due to uphill drive or drive with a high acceleration frequency that applies high load on the internal combustion engine 20a, the driver determination unit 12g may determine that the driver is the first driver. Note that if a driver uses the car-sharing system 1 for the first time, the information to be used in the determination may be estimated from information such as a destination, the number of people who uses the vehicle, or weather included in reservation information. In other words, part or all of the driver information for determining whether a certain driver is the first driver or not may be included in the reservation information.

In the second embodiment, the reservation determination unit 12i determines whether the reservation is a reservation which satisfies the condition (an example of the first condition), under which reduction of the deterioration degree of the oil may be expected or not based on the reservation information acquired from the terminal 30. The drive-mode prediction unit 12h predicts the drive mode of the vehicle 20 based on the reservation information. Moreover, the allocation unit 12j selects the vehicle 20, which satisfies the condition (reservation condition) determined by the reservation information, from among the vehicles 20 managed by the car-sharing system 1 and allocates the vehicle to the reservation. Note that, hereinafter, the reservation which may be expected to reduce the deterioration degree of the oil, in other words, the reservation, in which the drive that reduces the deterioration degree of the oil is highly possible, will be referred to as the first reservation as an example.

The flow chart illustrating the processing procedure of the reservation determination by the reservation determination unit 12i and allocation of the vehicle 20 to the reservation by the allocation unit 12j is similar to that of the first embodiment illustrated in FIG. 6. Note that, as a fourth condition, a case in which expected load of the internal combustion engine is equal to or higher than the threshold value may be included.

As described above, in the present embodiment, in the server 10 (vehicle allocation device), the vehicle determination unit 12d determines, for each vehicle 20, the necessity of reducing the deterioration degree of the oil in the internal combustion engine 20a based on the vehicle information corresponding to the vehicle 20. If the reservation information corresponding to a reservation satisfies the first condition, under which the deterioration degree of the oil may be expected to be reduced, the reservation determination unit 12i determines that the reservation is the first reservation. Moreover, if the reservation is the first reservation, the allocation unit 12j may allocate the vehicle 20, which has a higher necessity of reducing the deterioration degree of the oil than the other vehicles 20, to the reservation based on the reservation information.

According to the configuration and the control like this, the vehicle, which has a high necessity of reducing the deterioration degree of the oil, may be allocated to the first reservation, in which the deterioration degree of the oil may be expected. Therefore, deterioration of the oil in the internal combustion engine of the vehicle may be suppressed by allocation of the vehicle to the reservation. Moreover, shortening of the vehicle life may be suppressed by suppressing the deterioration of the oil. Moreover, occurrence of a situation in which vehicle assignment concentrates on particular vehicles and causes unbalance in the deterioration degrees of the oil may be suppressed.

Note that, if the control unit 12 of the server 10 or the control unit 22 of the vehicle 20 estimates that the water amount in the oil has exceeded a predetermined threshold value, the driver may be reminded to exchange the oil via in-vehicle information equipment such as a car navigation system or the terminal 30 regardless of the result of estimation of the deterioration degree. Alternatively, the driver may be reminded to carry out drive (for example, continuous drive of a certain degree) that reduces the deterioration degree of the oil.

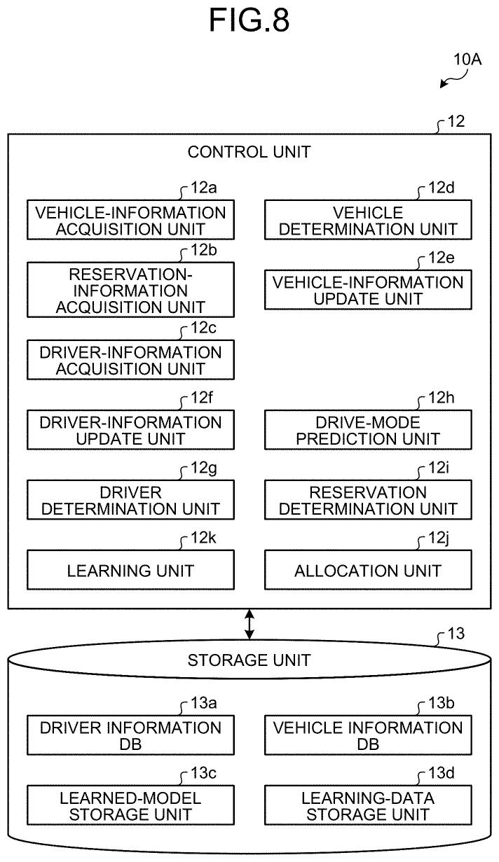

FIG. 8 is a block diagram of the control unit 12 and the storage unit 13 of a server 10A of the present embodiment. As illustrated in FIG. 8, in the present embodiment, the control unit 12 has a learning unit 12k. The driver determination unit 12g determines the driver by using a learned model generated by the learning unit 12k. Other than a point that the server 10A is provided instead of the server 10, the configuration of the car-sharing system 1 is similar to that according to the first embodiment.

The learning unit 12k carries out machine learning based on input/output data sets, which are part of the driver information. The learning unit 12k writes the learned model, which is a result of learning, in a learned-model storage unit 13c of the storage unit 13. The learning unit 12k may write, at predetermined timing, a learned model, which is the latest at the timing, in the learned-model storage unit 13c separately from the neural network, which is being learned. The writing of the learned model into the learned-model storage unit 13c may be update of deleting an old learned model and writing the latest learned model or may be accumulation of writing the latest learned model while causing part or all of old learned models to remain.

The storage unit 13 has the learned-model storage unit 13c and a learning-data storage unit 13d in addition to the driver-information database 13a and the vehicle-information database 13b. The learned-model storage unit 13c stores learned models in a searchable manner. Note that, at first, the learned-model storage unit 13c stores a learned model in an initial state. The learned model is a learned model generated based on deep learning using a neural network. Note that storing the learned model means storing information such as network parameters, algorithms of computation, etc. of the learned model. The learned model is stored in association with the driver information. Note that the learned model may be stored in further association with the vehicle information. Moreover, the learning-data storage unit 13d stores learning data. The learning data will be described later.

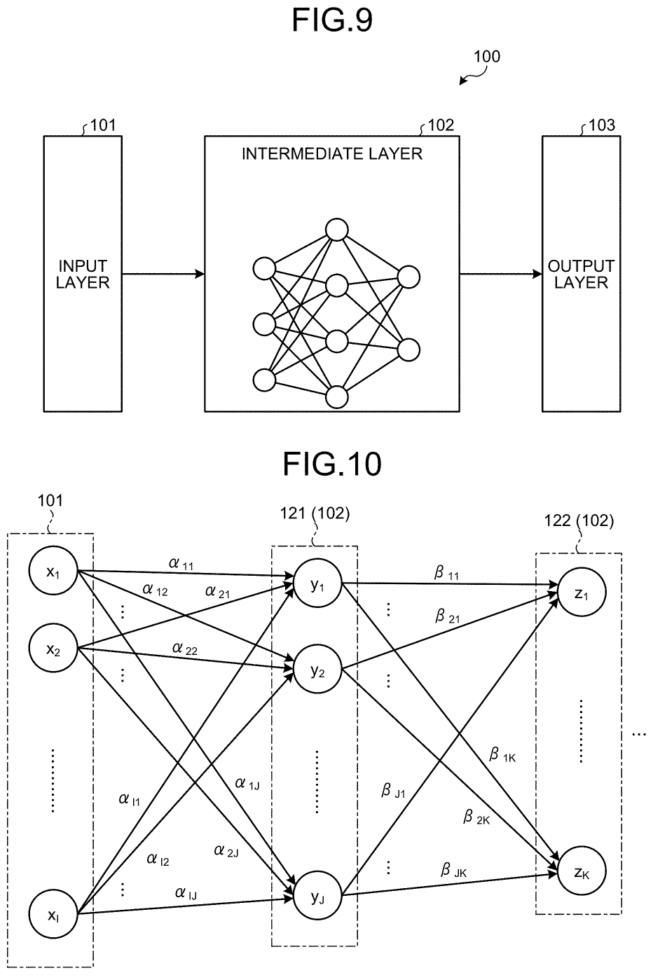

Herein, the deep learning using the neural network will be described as a specific example of machine learning. FIG. 9 is a diagram schematically illustrating a configuration of a neural network learned by the learning unit 12k. As illustrated in FIG. 9, a neural network 100 is a feedforward neural network and has an input layer 101, an intermediate layer 102, and an output layer 103. The input layer 101 includes a plurality of nodes, and mutually different input parameters are input to the nodes. The output from the input layer 101 is input to the intermediate layer 102. The intermediate layer 102 has a multilayer structure including layers including a plurality of nodes which receive input from the input layer 101. The output from the intermediate layer 102 is input to the output layer 103, and the output layer 103 outputs output parameters. The machine learning in which the intermediate layer 102 uses the neural network having the multi-layer structure is called deep learning.

FIG. 10 is a diagram describing general outlines of input/output at nodes of the neural network 100. FIG. 10 schematically shows part of the input/output of data in the input layer 101 having I nodes, a first intermediate layer 121 having J nodes, and a second intermediate layer 122 having K nodes in the neural network 100 (I, J, K are positive integers). An input parameter xᵢ (i=1, 2, . . . , I) is input to the i-th node from the top in the input layer 101. Hereinafter, a set of all input parameters will be described as “input parameters {xᵢ}”.

Each of the nodes of the input layer 101 outputs a signal having a value, which is obtained by multiplying the input parameter by a predetermined weight, to each node of the adjacent first intermediate layer 121. For example, the i-th node from the top of the input layer 101 outputs a signal, which has a value αᵢⱼxᵢ obtained by multiplying the input parameter xᵢ by a weight αᵢⱼ, to the j-th node (j=1, 2, . . . , J) from the top of the first intermediate layer 121. A value Σ_{i=1˜I}αᵢⱼxᵢ+b⁽¹⁾ⱼ obtained by adding a predetermined bias b⁽¹⁾ⱼ to the outputs from each node of the input layer 101 is input to the j-th node from the top of the first intermediate layer 121 in total. Herein, the first term Σ_{i=1˜I} means obtaining the sum of i=1, 2, . . . , I.

An output value yⱼ of the j-th node from the top of the first intermediate layer 121 is expressed as yⱼ=S(Σ_{i=1˜I}αᵢⱼxᵢ+b⁽¹⁾ⱼ) as a function of the value Σ_{i=1˜I}πᵢⱼxᵢ+b⁽ⁱ⁾ⱼ input to the node from the input layer 101. This function S is called an activating function. Specific examples of the activating function include a sigmoid function S(u)=1/{1+exp(−u)}, a rectified linear unit (ReLU)S(u)=max(0,u), etc. A non-linear function is often used as the activating function.

Each node of the first intermediate layer 121 outputs a signal having a value, which is obtained by multiplying the input parameter by a predetermined weight, to each node of the adjacent second intermediate layer 122. For example, the j-th node from the top of the first intermediate layer 121 outputs a signal, which has a value βᵢₖyⱼ obtained by multiplying the input value yⱼ by a weight βⱼₖ, to a k-th node (k=1, 2, . . . , K) from the top of the second intermediate layer 122. A value Σ_{j=1˜J}βⱼₖyⱼ+b⁽²⁾ₖ obtained by adding a predetermined bias b⁽²⁾ₖ to the outputs from each node of the first intermediate layer 121 is input to the k-th node from the top of the second intermediate layer 122 in total. Herein, the first term Σ_{j=1˜J} means obtaining the sum of j=1, 2, . . . , J.

The output value zₖ of the k-th node from the top of the second intermediate layer 122 is expressed as zₖ=S(Σ_{j=1˜J}βⱼₖyⱼ+b⁽²⁾ₖ) by using an activating function using the value Σ_{j=1˜J}βⱼₖyⱼ+b⁽²⁾ₖ input from the first intermediate layer 121 to the node as a variable.

In this manner, it is sequentially repeated along the forward direction from the side of the input layer 101 toward the output layer 103, one output parameter Y is output from the output layer 103 in the end. Hereinafter, the weight and bias included in the neural network 100 will be collectively referred to as a network parameter w. The network parameter w is a vector using all the weight and bias of the neural network 100 as components.

The learning unit 12k carries out computation of updating the network parameter w based on the output parameter Y calculated by inputting an input parameter {xᵢ} to the neural network 100 and an output parameter (target output) Y₀ constituting the input/output data set together with the input parameter {xᵢ}. Specifically, the network parameter w is updated by carrying out the computation of minimizing the error between the two output parameters Y and Y₀. In this process, stochastic gradient descent is often used. Hereinafter, the set ({xᵢ}, Y) of the input parameter {xᵢ} and the output parameter Y will be collectively referred to as “learning data”.

Hereinafter, general outlines of the stochastic gradient descent will be described. The stochastic gradient descent is a method of updating the network parameter w so as to minimize the gradient ∇_{w}E(w) obtained from the differential with respect to the components of the network parameters w of an error function E(w) defined by using the two output parameters Y and Y₀. The error function is defined, for example, by a squared error |Y−Y₀|² of the output parameter Y and the output parameter Y₀ of the input/output data set of the learning data. Moreover, the gradient ∇_{w}E(w) is a vector having ∂E(w)/∂αᵢⱼ, ∂E(w)/∂βⱼₖ, ∂E(w)/∂b⁽¹⁾ⱼ, ∂E(w)/∂b⁽²⁾ₖ (herein, i=1 to I, j=1 to J, k=1 to K), etc. as components, which are differentials about the component of the network parameter w of the error function E(w).

In the stochastic gradient descent, the network parameter w is sequentially updated like w′=w−η∇_{w}E(w), w″=w′−η∇_{w′}E(w′) and so on by using a predetermined learning rate η which is automatically or manually determined. Note that the learning rate η may be changed in the middle of learning. In a case of more general stochastic gradient descent, an error function E(w) is defined by random extraction from samples including all learning data. The number of the learning data extracted in this process is not necessarily limited to one, but may be part of the learning data stored by the learning-data storage unit 13d.

As a method for efficiently carrying out the calculation of a gradient ∇_{w}E(w), backpropagation is known. The backpropagation is a method of carrying out calculations by tracking components of the gradient ∇_{w}E(w) from the output layer, the intermediate layer, and the input layer in this order based on the error between the target output Y₀ and the output parameter Y of the output layer after the learning data ({xᵢ}, Y) is calculated. The learning unit 12k calculates all the components of the gradient ∇_{w}E(w) by using the backpropagation and then updates the network parameter w by applying the above described stochastic gradient descent by using the calculated gradient ∇_{w}E(w).

The learning unit 12k extracts the driver information, which is to be used in the machine learning, from the driver information stored in the driver-information database 13a. The input parameters of the machine learning are the information indicating the past drive records of the driver such as an average speed, a drive distance, drive time, the number of times of acceleration at predetermined acceleration or higher, and average acceleration in acceleration, for example. Moreover, the output parameters of the machine learning are, for example, a category indicating whether the driver is the first driver or not and the amount of change of the particulate matters per unit length of the drive distance or the amount of change of the particulate matters per unit time of drive time in the drive by the driver. The amount of change of the particulate matters indicates that, for example, the smaller the value, the higher the reduced amount of the accumulated particulate matters, wherein increase is positive, and reduction is negative. Note that, the input parameters may include the attribute information of the driver such as the gender, age, resident area, occupation, and hobbies of the driver, for example.

The learning by the learning unit 12k is executed at predetermined timing, for example, every time the driver information is added or updated. As a result, in the learned-model storage unit 13c, the learned models associated with the driver information are accumulated. Moreover, the learning unit 12k may further associate the generated learned models with the vehicle information and accumulate them in the learned-model storage unit 13c. The learning unit 12k may update the learned model, which has been generated in the past, by a new learned model having a high degree of match with the driver information with which this learned model is associated. Furthermore, the learning unit 12k may generate a new learned model, for example, by averaging by mutually merging a plurality of learned models, which have mutually close driver information associated. Note that if the learned models are to be averaged, it may be carried out by averaging, for each node, the respective network parameters w of a plurality of learned models. Moreover, the learning unit 12k may change the number of the nodes. Moreover, the learning unit 12k may merge or update the plurality of learned models by further checking the vehicle information. In this manner, the generated learned models are stored in the learned-model storage unit 13c by accumulating, updating, or merging and averaging.

In such a configuration, the driver determination unit 12g selects at least one learned model associated with the driver information having the highest degree of match from the learned-model storage unit 13c based on the driver information associated with the identification information of the driver serving as a target of determination when determination of the driver is to be carried out.

Then, the driver determination unit 12g inputs the driver information to the selected learned model as an input parameter, thereby acquiring, as an output parameter, the category indicating whether the driver is the first driver or not and the amount of change of the particulate matters per unit length of the drive distance or the amount of change of the particulate matters per unit time of the drive time in the drive by the driver. By using the learned model, the probability of reduction of the particulate matters in the drive by the driver may be more accurately estimated even in a stage in which the driver information indicating the record of the drive by the driver is comparatively low.

In the above described third embodiment, the possibility of reducing the particulate matters by the driving by the driver is estimated like the first embodiment, but the possibility of reducing the deterioration degree of the oil by the driving by the driver may be estimated like the second embodiment.

Hereinabove, the embodiments of the present disclosure have been described. However, the above described embodiments are examples and have no intention to limit the scope of the present disclosure. The above described embodiments may be carried out in various other modes, and various omission, replacement, combination, and changes may be made within the range not departing from the gist of the disclosure. Moreover, specs (structure, type, model, number, layout, etc.) such as configurations and shapes may be appropriately changed and implemented.

For example, in the above described embodiments, one server handles all the functions as the vehicle allocation device, but is not limited thereto. A plurality of computers communicatably connected via a network may share the functions. Moreover, the storage device may be communicatably connected to a device which executes processing via the network.

Moreover, in a case in which the driver information is included in the reservation information, if the driver information satisfies the third condition, the reservation determination unit may determine that the driver is the first driver and determine that the reservation as the first reservation. The driver information included in the reservation information is attribute information or the like of the driver such as the information that indicates a planned stopover, a planned drive route, and usage or non-usage of express ways.

Moreover, the present disclosure may be similarly applied also to, for example, a system which allocates any of a plurality of vehicles to a reservation such as a rental car system other than car-sharing system.

According to the vehicle allocation device, the vehicle allocation method, and the computer readable recording medium storing the program of the present disclosure, lowering of the performance of the internal combustion engine in the vehicle may be suppressed by allocation of the vehicle to a reservation.

According to the present disclosure, the vehicle allocation device may allocate the vehicle, which has a high necessity of suppressing lowering of the performance, to the first reservation, in which suppression of lowering of the performance of the internal combustion engine is expected. Therefore, lowering of the performance of the internal combustion engine may be suppressed by the allocation of the vehicle to the reservation.

Moreover, in the vehicle allocation device, the necessity of suppressing lowering of the performance of the internal combustion engine is the necessity of reducing the particulate matters accumulated on the particle filter provided in an exhaust path of the internal combustion engine.

According to such a configuration, the vehicle allocation device may allocate the vehicle, which has the high necessity of reducing the accumulated particulate matters, to the first reservation, in which the particulate matters accumulated on the particle filter may be expected to be reduced by combustion. Therefore, accumulation of the particulate matters in the vehicle may be suppressed by allocation of the vehicle to the reservation.

Moreover, in the vehicle allocation device, the necessity of suppressing lowering of the performance of the internal combustion engine is the necessity of reducing the deterioration degree of the oil in the internal combustion engine.

According to such a configuration, deterioration of the oil in the internal combustion engine of the vehicle may be suppressed by allocating the vehicle to the reservation since the vehicle allocation device may allocate the vehicle, which has a high necessity of reducing the deterioration degree of the oil, to the first reservation, in which reduction of the deterioration degree of the oil in the internal combustion engine may be expected.

According to the present disclosure, the vehicle allocation device may allocate the vehicle, which has a high necessity of suppressing lowering of the performance, to the reservation, in which a driver who is expected to suppress lowering of the performance of the internal combustion engine. Therefore, lowering of the performance of the internal combustion engine in the vehicle may be suppressed at higher probability.

According to the present disclosure, the vehicle allocation device may determine whether the driver is the driver expected to suppress lowering of the performance of the internal combustion engine from a drive record and allocate the vehicle, which has a high necessity of suppressing lowering of the performance, to the reservation, in which the driver who has been determined to be expected to suppress lowering of the performance drives. Therefore, lowering of the performance of the internal combustion engine in the vehicle may be suppressed at higher probability.

Moreover, if driver information corresponding to a driver included in the reservation information satisfies a third condition, under which lowering of the performance may be expected, the reservation determination unit determines that the driver is a first driver; and, if the reservation is a reservation, in which the first driver is to drive the vehicle, the reservation determination unit determines the reservation as the first reservation.

According to such a configuration, the reservation determination unit may determine the first driver from the reservation information and suppress lowering of the performance of the internal combustion engine in the vehicle.

According to the present disclosure, the vehicle allocation device may determine whether the reservation is a first reservation in which suppression of lowering of the performance of the internal combustion engine is expected or not from planned path information and allocate the vehicle, which has a high necessity of suppressing lowering of the performance, to the first reservation. Therefore, lowering of the performance of the internal combustion engine in the vehicle may be suppressed at higher probability.

According to the present disclosure, the vehicle allocation device may determine whether the reservation is a first reservation in which suppression of lowering of the performance of the internal combustion engine is expected or not from a planned drive route and a planned stopover and allocate the vehicle, which has a high necessity of suppressing lowering of the performance, to the first reservation. Therefore, lowering of the performance of the internal combustion engine may be suppressed at higher probability.

According to the present disclosure, the vehicle allocation device may determine whether the reservation is a first reservation in which suppression of lowering of the performance of the internal combustion engine is expected or not from a drive mode predicted from reservation information and allocate the vehicle, which has a high necessity of suppressing lowering of the performance, to the first reservation. Therefore, suppression of lowering of the performance of the internal combustion engine in the vehicle may be suppressed at higher probability.

According to the present disclosure, the vehicle allocation device may determine whether the reservation is a first reservation in which suppression of lowering of the performance of the internal combustion engine is expected or not from a drive mode of the driver predicted from reservation information and driver information and allocate the vehicle, which has a high necessity of suppressing lowering of the performance, to the first reservation. Therefore, lowering of the performance of the internal combustion engine in the vehicle may be suppressed at higher probability.

According to the present disclosure, the vehicle allocation device may determine whether the reservation is a first reservation in which suppression of lowering of the performance of the internal combustion engine is expected or not based on an average speed, a drive distance, drive time, expected load of the internal combustion engine, and the number of times of acceleration predicted from reservation information and allocate the vehicle, which has a high necessity of suppressing lowering of the performance, to the first reservation. Therefore, lowering of the performance of the internal combustion engine in the vehicle may be suppressed at higher probability.

According to the method disclosed in the present disclosure, the vehicle, which has a high necessity of suppressing lowering of the performance, may be allocated to the first reservation, in which suppression of lowering of the performance of the internal combustion engine is expected. Therefore, lowering of the performance of the internal combustion engine in the vehicle may be suppressed by the allocation of the vehicle to the reservation.

According to the computer readable recording medium storing the program disclosed in the present disclosure, the vehicle, which has a high necessity of suppressing lowering of the performance, may be allocated to the first reservation, in which the suppression of lowering of the performance of the internal combustion engine is expected. Therefore, lowering of the performance of the internal combustion engine in the vehicle may be suppressed by the allocation of the vehicle to the reservation.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A vehicle allocation device comprising
a processor comprising hardware, the processor being configured to:
determine, for each vehicle, a necessity of suppressing lowering of performance of an internal combustion engine based on vehicle information corresponding to the vehicle;
determine a reservation as a first reservation when reservation information corresponding to the reservation of renting the vehicle satisfies a first condition under which suppressing of lowering of the performance is expected; and
allocate the vehicle to the reservation based on the reservation information, wherein
the processor is configured to allocate, in a case where the reservation is the first reservation, the vehicle satisfying a second condition indicating a high necessity of the suppression of lowering of the performance or the vehicle having a higher necessity of the suppression of lowering of the performance than the other vehicle to the reservation.

2. The vehicle allocation device according to claim 1, wherein the necessity of suppressing lowering of the performance of the internal combustion engine is a necessity of reducing a particulate matter accumulated on a particle filter provided on an exhaust path of the internal combustion engine.

3. The vehicle allocation device according to claim 1, wherein the necessity of suppressing lowering of the performance of the internal combustion engine is a necessity of reducing a deterioration degree of oil in the internal combustion engine.

4. The vehicle allocation device according to claim 1, wherein the processor is configured to:
determine a driver as a first driver when driver information corresponding to the driver satisfies a third condition under which suppression of lowering of the performance is expected; and
determine the reservation as the first reservation when the reservation is a reservation that the first driver is to drive the vehicle.

5. The vehicle allocation device according to claim 4, wherein the driver information is information indicating a drive record of the driver.

6. The vehicle allocation device according to claim 1, wherein the processor is configured to:
determine that the driver as a first driver in a case where driver information corresponding to a driver included in the reservation information satisfies a third condition under which suppression of lowering of the performance is expected; and
determine that the reservation is the first reservation in a case where the reservation is a reservation in which the first driver drives the vehicle.

7. The vehicle allocation device according to claim 1, wherein the processor is configured to determine whether or not the reservation is the first reservation based on planned path information included in the reservation information.

8. The vehicle allocation device according to claim 7, wherein the processor is configured to determine the reservation as the first reservation in a case where the planned path information includes a predetermined road as a planned drive route or includes a location serving as a planned stopover distant from a reference position by a predetermined distance.

9. The vehicle allocation device according to claim 1, wherein the processor is configured to:
predict a drive mode of the vehicle from the reservation information; and
determine the reservation as the first reservation in a case where information indicating the drive mode satisfies a fourth condition under which suppression of lowering of the performance is expected.

10. The vehicle allocation device according to claim 9, wherein the processor is configured to predict the drive mode of the vehicle from the reservation information and driver information corresponding to a driver who is to drive the vehicle in the reservation.

11. The vehicle allocation device according to claim 9, wherein information indicating the drive mode is at least one of information indicating a predicted average speed, information indicating a predicted drive distance, information indicating predicted drive time, expected load of the internal combustion engine, and information indicating a predicted number of times of acceleration.

12. A method of allocating a vehicle, the method comprising:
determining, for each vehicle, a necessity of suppressing lowering of performance of an internal combustion engine based on vehicle information corresponding to the vehicle read from a storage unit;
determining a reservation as a first reservation when reservation information corresponding to the reservation of renting the vehicle satisfies a first condition under which suppression of lowering of the performance is expected; and
allocating, based on the reservation information, the vehicle to the reservation, wherein in the allocating, in a case where the reservation is the first reservation, the vehicle satisfying a second condition indicating a high necessity of the suppression of lowering of the performance or the vehicle having a higher necessity of the suppression of lowering of the performance than another vehicle is allocated to the reservation.

13. A non-transitory computer-readable recording medium on which an executable program is recorded, the program causing a processor of a computer to execute:
determining, for each vehicle, a necessity of suppressing lowering of performance of an internal combustion engine based on vehicle information corresponding to the vehicle read from a storage unit;
determining a reservation as a first reservation when reservation information corresponding to the reservation of renting the vehicle satisfies a first condition under which suppression of lowering of the performance is expected; and
allocating, based on the reservation information, the vehicle to the reservation, wherein in the allocating, in a case where the reservation is the first reservation, the vehicle satisfying a second condition indicating a high necessity of the suppression of lowering of the performance or the vehicle having a higher necessity of the suppression of lowering of the performance than another vehicle is allocated to the reservation.
